(19) United States
(12) Patent Application Publication
(10) Pub. No.: US 2025/0062526 A1
(43) Pub. Date: Feb. 20, 2025

(54) STRUCTURE FOR ANTENNAE

(71) Applicant: THALES NEDERLAND B.V., HENGELO (NL)

(72) Inventor: Robert FENNIS, HENGELO (NL)

(21) Appl. No.: 18/720,583

(22) PCT Filed: Dec. 19, 2022
(86) PCT No.: PCT/EP2022/086732

§ 371 Date: Jun. 14, 2024

(30) Foreign Application Priority Data
Dec. 21, 2021 (NL) 2030203

(51) Int. Cl. H01Q 1/52; H01Q 21/06

(52) U.S. Cl. CPC H01Q 1/523; H01Q 21/061

(57) ABSTRACT

To limit interference between antennas such as radar patch antennas in a structure, rows of pin elements are provided intersecting a propagation path on the surface of the structure. These rows may comprise inner and outer rows separated by a predetermined distance determined as a function of the operating frequency of the antennas. One or more intermediate rows may be provided between the inner and outer rows. The length and diameter of pin elements as well as the spacing between pin elements of a given row, may equally be selected with a view to the operating frequency of the antennas. The pin elements of the inner and outer rows may be offset with respect to each other.

### FIELD OF THE INVENTION

The present invention relates to the field of antennae, and structures for incorporating antennae.

### BACKGROUND PRIOR ART

In radar systems, there is a constant need for improvement in range and tracking capabilities. In the past, rotating antenna systems with reflectors have been used to direct the beam at a target. The introduction of more advanced electronic systems allowed for the individual control of antenna elements, and this allows for electronic beam steering in one or two dimensions. Electronic beam steering is much quicker than mechanic beam steering which allows for the tracking of multiple targets simultaneously. Besides advanced electronic beam steering technologies higher signal powers allows for a significant increase in range which is desirable when manufacturers are trying to meet more stringent demands of lower signatures of targets and higher velocities. Developments in Gallium Nitride (GaN) power amplifiers show a clear trend to more and more RF output power, by virtue of improved heat transfer in the radio frequency (RF) integrated circuit (IC) and in IC packages to a cooling manifold. Obviously, the generated output power has to pass the antenna. Printed circuit board (PCB)-based antennas such as patch antennas use transmission lines that cannot tolerate higher power levels due to dielectric and conduction losses. Cooling the antenna is not always enough, especially when components are thermally isolated. At very high power levels, air filled waveguides have low losses. One downside of open-ended waveguides versus patch antennas is that large arrays of open-ended waveguides are much more difficult and thus expensive to fabricate. But due to recent developments of metal 3D printing technologies, these fabrication costs can be reduced significantly. When constructing phased array antennas, one ideally wants to maximize the element spacing to maximize the gain without introducing grating lobes. Here grating lobes are extra unwanted directions of transmission. The antenna gain is directly proportional to the surface area of the antenna. This means that a larger antenna spacing directly allows one to increase the surface area and thus gain without increasing the cost due to additional electronics. The large size of some antenna geometries such as the open-ended waveguide antennas forces one to increase the antenna grid spacing correspondingly. At scan angles where grating lobes are present, one might also find blind spots. At these angles, propagation modes along a surface increase the mutual coupling which increases the active S₁₁ parameter, that is, the coefficient of reflection indicating the ratio between the back scattered field and the incident field. The antenna spacing can also become electrically longer for antennas realized on printed circuit boards due to the fact that the higher dielectric constant of the printed circuit board slows down the electromagnetic wave. Blind spots can therefore be a problem for larger antenna grid spacings or antenna arrays in dielectric media in general.

Phased array antennas are arrays of antenna elements on a two-dimensional grid. The phase and amplitudes of each antenna can be controlled electronically or digitally which allows the operator to control the shape and direction of the beam at will.

In many contexts, multiple separate antenna arrays may be installed in the same structure, and where this is the case interference may occur between respective antennae. These interference problems are related to propagation of EM surface waves over and around the surface of the structure from a transmitting antenna to a receiving antenna integrated in the walls of the same structure. A number of approaches to mitigating EM interference between two phased array antennas placed in same structure or between a phased array antenna and other transmitting or receiving antennas that are integrated in the structure are known.

Arrays may be situated with a view to interference considerations, for example by locating arrays and other equipment at sufficient distance and/or by locating them at different sides of the structure.

The structure itself may by shaped so as to limit interference.

The structure itself may be formed from RF absorbing materials

The structure may be provided with specific periodic structures, also known as meta materials, placed on or integrated in the walls to mitigate surface waves.

The structure may be provided with surface formations comprising pins in a dielectric medium for suppressing waves in general, see attached paper “Electromagnetic Characterization of Textured Surfaces Formed by Metallic Pins”.

The use of Sievenpiper mushrooms in a patch antenna, see attached paper “Elimination of Scan Blindness in Phased Array of Microstrip Patches Using Electromagnetic Bandgap Materials”.

General solutions as placing antennas at different sides of the structure or at sufficient distance or shaping the structure do not always provide sufficient mitigation of surface waves and is not always practical to implement.

Also other proposed solutions in prior art as metamaterials and absorbing materials are not practical, difficult or expensive to implement

It is accordingly desired to develop new radar structures better addressing the foregoing considerations.

### SUMMARY OF THE INVENTION

In accordance with the present invention in a first aspect there is provided an structure comprising two or more antennas, a first said antenna being arranged in a first surface of said structure and a second said antennae in a second surface of said structure, and a plurality of conductive pin elements arranged in one or more parallel rows intersecting a propagation path between said first antenna and said second antenna.

In a development of the first aspect, the plurality of conductive pin elements are arranged at a periphery of said antenna.

In a development of the first aspect, the plurality of conductive pin elements are arranged in one or more rows parallel to a periphery of said antenna.

In a development of the first aspect, the plurality of conductive pin elements is arranged in two or more rows parallel to said periphery of said antenna.

In a development of the first aspect, the antenna is designed to operate at a predetermined wavelength, and wherein said two or more rows comprise at least an inner row and an outer row, wherein of the main axis of said inner row is separated from the main axis of said outer row by a distance greater than one said wavelength.

In a development of the first aspect, each conductive pin element of said inner row is separated from a nearest said conductive pin element of said outer row by a distance greater than 2 time said wavelength.

In a development of the first aspect, each conductive pin element of said inner row is separated from a nearest said conductive pin element of said outer row by a distance greater than 3 times said wavelength.

In a development of the first aspect, the distance between each adjacent pair of pins in a given said row is a predetermined distance.

In a development of the first aspect, the diameter of each pin is less than said predetermined distance.

In a development of the first aspect, the pins of a first said row are offset with respect to a second, adjacent said row parallel to said first row, along the axis of said first row, by an amount between 0.5 times the distance between adjacent pins in the same row and zero.

In a development of the first aspect, each pin is formed contiguously with the structure.

In a development of the first aspect, each said pin is formed monolithically with the structure.

In a development of the first aspect, the first antenna comprises a two dimensional array of radiating elements, and a proximal extremity of each said pin in at least one said row coincides with said plane of said two-dimensional array.

In a development of the first aspect, the first antenna comprises a plurality of radiating elements, and no pins are provided between said radiating elements.

In a development of the first aspect, the plurality of conductive pin elements are arranged in one or more rows parallel to an outer periphery of said plurality of radiating elements.

In a development of the first aspect, the length of the pins is longer than the speed of light in the medium in which the pins are embedded, divided by four times the lower frequency limit (f1) of the waveguide and shorter than the speed of light in the medium in which the pins are embedded, divided by two times the lower frequency limit (f1).

In a development of the first aspect, at least a second said antenna is positioned in a second surface of said physical structure, wherein said first surface and said second surface are in different planes.

### BRIEF DESCRIPTION OF THE DRAWINGS

The invention will be better understood and its various features and advantages will emerge from the following description of a number of exemplary embodiments provided for illustration purposes only and its appended figures in which:

FIG. 1 shows a structure 100 such as a mast comprising a first antenna 110 and a second antenna;

FIG. 2a shows a first example of an intersection of the plane of the two-dimensional array;

FIG. 2b shows a second example of an intersection of the plane of the two-dimensional array;

FIG. 2c shows a third example of an intersection of the plane of the two-dimensional array;

FIG. 3a provides a plan view of a plurality of pin elements in a first configuration;

FIG. 3b provides a plan view of a plurality of pin elements in a second configuration;

FIG. 3c provides a plan view of a plurality of pin elements in a third configuration;

FIG. 4a shows a first intermediate row configuration;

FIG. 4b shows a second intermediate row configuration;

FIG. 4c shows a second intermediate row configuration;

FIG. 5 presents a first configuration with multiple sets of rows; and

FIG. 6 presents a first configuration with multiple sets of rows.

### DETAILED DESCRIPTION OF THE INVENTION

It is desired to mitigate EM interference between two phased array antennas placed in same structure or more generally between an antenna and other transmitting or receiving antennas that are integrated in the said structure. These interference problems are related to propagation of EM surface waves over and around the surface of the structure from a transmitting antenna to a receiving antenna integrated in the walls of the same structure. In accordance with embodiments, the propagation of EM surface waves to and/or from the phased array antenna panels is mitigated by a matrix of pin elements disposed in a propagation path as discussed below.

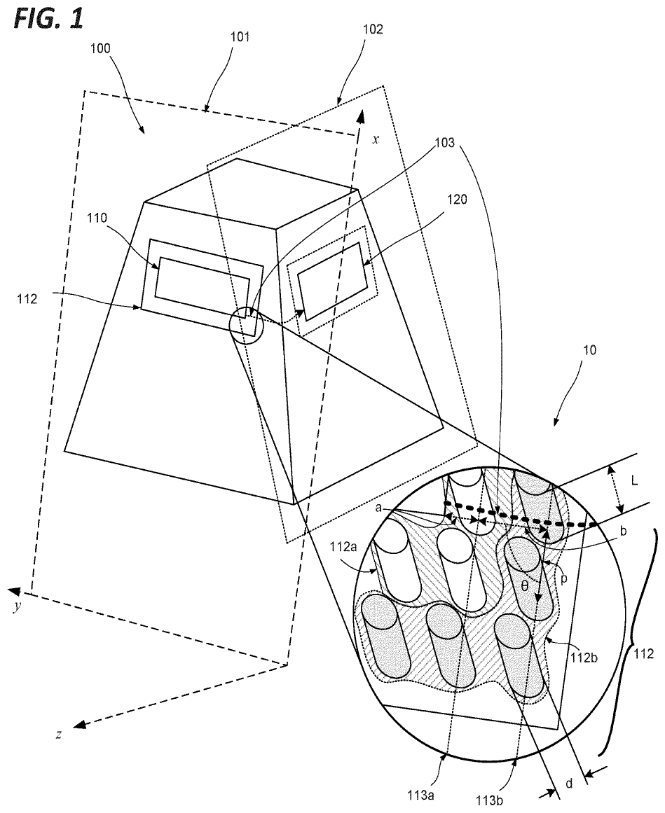

FIG. 1 shows a structure 100 such as a mast comprising a first antenna 110 and a second antenna 120. The first antenna 110 is arranged in a first surface of said structure 101 and the second antenna 120 is arranged in a second surface of said structure 102. As shown, the surfaces conform to respective planes, shared by the respective antennas, however other arrangements may be envisaged. As shown in magnified section 10, the structure 100 further comprises a plurality of conductive pin elements 112 arranged in one or more parallel rows 112a, 112b along respective main axes 113a, 113b, intersecting a propagation path between said first antenna and said second antenna. The pins are not necessarily in air, but can be located in a dielectric medium (not shown). The pin elements are preferable substantially cylindrical. Although as shown the first and second surfaces are not aligned, in other embodiments the first and second surfaces of said structure may be aligned, that is to say that the second plane is in the first plane.

In certain embodiments the pins may be arranged substantially perpendicularly to the surface of the structure.

It will be appreciated that while main axes 113a, 113b are introduced as a basis for the present description, only a part of each row may be situated on such a respective main axis, and other parts of a particular row may deviate from this axis, as shown, such that each row may form an arbitrary shape as may be appropriate in view of the geometry of the structure, the shape of the antennas, etc. Some such options are mentioned in the following description. The disposition of the rows is dictated by the determination of values a, b, d and p as discussed below.

Although the rows may be situated as expedient, insofar as they intersect a propagation path between said first antenna and said second antenna, in certain embodiments the plurality of conductive pin elements may be arranged in one or more rows parallel to a periphery of said first antenna. They may follow part of the periphery of the antenna, and optionally surround the whole antenna. For example, the pin elements may be disposed preferentially at a part of the periphery that is facing neighbouring/adjacent antenna.

As shown, the radiating the plurality of conductive pin elements may be arranged in two or more rows 112a, 112b, possibly parallel to the periphery of the first antenna. In this sense, the shaded pins of FIG. 1 constitute an outer row, and the unshaded pins constitute an inner row.

The first antenna 110 may be designed to operate at a predetermined wavelength, in which case the two or more rows may comprise at least an inner row 112a and an outer row 112b. In such a configuration, the main axis of the inner row 112a may preferably be separated from the main axis of the outer row 112b by a distance greater than the operating wavelength of the first antenna. More precisely the main axis of the inner row 112a may be separated from the main axis of the outer row 112b by a distance b as discussed below, or in embodiments having more than two parallel rows, a corresponding multiple of b.

Generally speaking it will be desirable to provide as many adjacent rows as the available space permits. This may correspond to a distance between the main axis of the inner row 112a and the main axis of the outer row 112b of greater than one wavelength, greater than three wavelengths, or greater than 10 wavelengths, or any number as dictated by the available space (the distance between the adjacent rows always being b).

Deviations may occur for example where the geometry of the structure or the shape of an antenna imposes a sharp turn in a row, e.g. at the corner as shown in FIG. 1. In any case, this distance may preferable by greater than twice the operating wavelength of the first antenna. Still more preferably this distance may be greater than 3 times said wavelength.

The distance p between each adjacent pair of pins in a given row may be a predetermined distance. This distance may be generally equal for all conductive pin elements in the same given row. Deviations may occur for example where the geometry of the structure or the shape of an antenna imposes a sharp turn in a row, e.g. at the corner as shown in FIG. 1. This distance may be equal for all conductive pin elements.

The distances b and p are determined substantially on the basis of the same underlying principles as discussed further below, and in some embodiments these distances may be equal. In other embodiments b and p may have different values, while still both satisfying the criteria described below.

FIG. 1 shows a band of pins 112 surrounding the antenna 110. It will be appreciated that this band not necessarily be continuous, and that in accordance with certain embodiments the band of pin elements may correspond to one side of the antenna, two sides of the antenna, three sides of the antenna, or continuous or broken sections corresponding to any number of sides.

The distance a between the edge of the antenna 111 and the inner row of pin elements 112a may be any distance. As shown, the distance is relatively small, in the same order of magnitude as distance b and p for example, however in other embodiments the distance may be substantially greater, up to the edge of the surface in which the first antenna and associated pin elements are provided.

The distance between each adjacent pair of pins in a given said row p is a predetermined distance as described in more detail below. As discussed above, the same calculations may be used in determining the distance between adjacent rows b, however for the sake of simplicity the following discussion will refer only to b. As discussed below, for optimal operation the plasma frequency fₚ is preferably higher than the operating band of the antenna. In the definition as presented in the equation below both p and p/r (radius r=d/2) play a role in the value of fₚ. For proper operation fₚ>>f_{operating} (=c₀/λ) with p/r>4. In preferred embodiments having more than 2 rows of pins this implies that p<0.25λ.

The spaced conductive pin elements are grounded, for example by connection to a conducting surface. The wire lattice acts as a low frequency anisotropic metal. Metals reflect electromagnetic waves below a certain frequency called the plasma frequency. The mobility of the electrons in a metal enables them to oppose incoming waves and reflect them.

Because of the limited mobility of the electrons, electromagnetic waves with a frequency higher than the plasma frequency can partially pass through the metal. The properties of these materials can be modelled via a frequency dependent dielectric permittivity model called Drude's model for metals.

Above the plasma frequency, the dielectric constant 0<εᵣ<1 and waves can pass through. For metals, the plasma frequency is typically above the visible spectrum.

For a lattice constant smaller than the wavelength, the wire medium can be thought of as an anisotropic metal as it behaves as a metal for incoming waves that have the electric field polarized parallel to the wires. The plasma frequency however can be tuned at will by means of the lattice spacing and wire radius. For waves with the electric field polarized perpendicular to the wire direction, the wire medium is transparent and a normal TEM mode is allowed to exist.

The plasma frequency of this material in air can be approximated via a simple formula if the assumption is made that the ratio of the lattice spacing a to the wire radius r is at least 10 or larger (p/r>10), bearing in mind that the formula is only exact for infinitely thin wires but sufficiently accurate as long as p/r>10.

$${f}_{p} = \frac{\frac{{c}_{0}^{2}}{2 π {p}^{2}}}{ln ( \frac{p}{2 π r} ) + 0.5275}$$

The spacing c between adjacent pins in the same row, and between adjacent rows may be constant, or may be varied across the array. Generally, it is advantageous for a strong coupling reduction that the amount of rows of pins is maximized. This implies that p is small compared to lambda.

Each pin has a diameter d. The diameter of each pin is preferably less than the predetermined distance as defined above. For example, the diameter of each pin is preferably less than the distance by which each pin element of the inner row 112a is separated from a nearest conductive pin element of the outer row 112b.

If the wire radius is made smaller compared to the lattice spacing the plasma frequency will decrease and when the radius is made larger, the plasma frequency will approach c₀/p.

Accordingly, the diameter of each pin is preferably less than the predetermined distance between elements in the same row, p.

In any embodiment, the conductive pins may be formed with respect to the structure in a variety of manners. For example, each pin may be formed contiguously with the respective the structure, that is to say, that while each pin is formed separately from the structure, it is placed in electrical contact therewith.

Alternatively, each pin may be formed monolithically with the structure, that is to say, that each pin is formed of the same material and in a single piece with the structure. Still further, pins may be physically and/or separated from the structure, and connected to ground by a separate conductive matrix. The pins may by physically discrete elements which are inserted into corresponding sockets in the structure. Alternatively, the pins might also be separated from the structure by an isolating sheet such that they are electrically connected at RF frequencies, but not at DC.

The structure may comprise a conductive material, and may be connected to electrical ground. Where this is the case, each pin may be formed contiguously with the structure, e.g. having been screwed, riveted, push fitted or otherwise brought into mechanical and electrical engagement therewith. Still further, each said pin may be formed monolithically with the structure, for example by welding or soldering thereto, or by being stamped, moulded, cast, printed by additive manufacturing methods, sintered, machined or otherwise formed from a single substrate.

Still further, a plurality of pin elements may be formed on or as part of a thin substrate that may be glued, soldered, riveted or otherwise mounted on the structure. This might conveniently tape the form of a flexible tape, which may be conductive, or not, in line with the foregoing embodiments. For example, pin elements might be formed as part of a continuous aluminium alloy band that may easily be applied to the surface of the structure as generally presented herein.

The first antenna may comprise any radiating device as may occur to the skilled person. In particular, the first antenna may comprise a two dimensional array of radiating elements for example in a beam steering configuration, comprising for example multiple waveguide or patch antenna elements. In such configurations, a proximal extremity of each pin in at least one said row coincides with said plane of said two-dimensional array. Such a two dimensional array may form an antenna which is substantially circular, oval, ridged or rectangular for example. Where the first antenna comprises a plurality of radiating elements, e.g. in an array configuration, preferably no pins are provided between the radiating elements.

FIG. 1 shows a band of pins 112 surrounding the antenna 111. It will be appreciated that this band not necessarily be continuous, and that in accordance with certain embodiments the band of pins may correspond to one side of the antenna, two sides of the antenna, three sides of the antenna, or continuous or broken sections corresponding to any number of sides.

The distance a between the edge of the antenna 111 and the inner row of pins 112a may be any distance. As shown, the distance is relatively small, in the same order of magnitude as distance b and c for example, however in other embodiments the distance may be substantially greater, up to the edge of the surface in which the first antenna and associated pins are provided.

When the operating frequency is sufficiently far below the materials plasma frequency, a grounded slab of this medium can be shown to allow Plane Trapped Surface Wave (PTSW) modes at periodic intervals depending on the height of the medium. This is a very desirable property because now its frequency dependent behaviour is no longer a function of its geometry in the direction of propagation but rather orthogonal to it.

Grounding conducting pins into arrangements as described above yields a certain set of PTSW modes. An approximate model for the horizontal propagation constant k_{∥} of a grounded wire medium in air can be made which assumes an infinite plasma frequency:

$$\frac{{k}_{‖}}{{k}_{0}} = \sqrt{{tan}^{2} ( \frac{2 π fL}{{c}_{o}} ) + 1}$$

Where k₀=ω/c and kₚ the plasma wave number kₚ=2πfₚ/c₀ and L the length of the wires.

The solution for the horizontal propagation constant emerges as the plasma frequency approaches infinity:

$${k}_{0} tan ( {k}_{m} L ) = {ε}_{r} {γ}_{0} = {ε}_{r} \sqrt{{k}_{‖}^{2} - {k}_{0}^{2}}$$

Here γ₀ is the damping factor of the wave above the wire medium in the vertical Z direction.

It may be borne in mind that the model of equation 12 calculates the solutions in the passband only as it also predicts solutions in the stop band that are incorrect. Equation 13 meanwhile specifies this same relation but without the inclusion of solutions in the stop band.

Mathematically the cutoff regions of the wire medium can be written as:

$$π n + \frac{π}{2} < \frac{2 π fL}{{c}_{0}} < π n ,$$

$$n = 0 , \pm 1 , \pm 2 , \pm 3 , …$$

Which can be simplified to find the stop band regions for values of n=[0, 1, 2, . . . , n],

$$\frac{{c}_{0}}{2 L} ( n + \frac{1}{2} ) < f < \frac{{c}_{0}}{2 L} ( n + 1 )$$

Bearing in mind that while n=0, ±1, ±2 etc is the entire set of solutions mathematically, in practice only the set of solutions for n=1, 2, 3, 4 and onwards is important because negative frequencies are not physically interesting but rather more mathematical.

From this it is possible to write the first stopband for n=0 as

$$\frac{{c}_{0}}{4 L} < f < \frac{{c}_{0}}{2 L}$$

On this basis, the length of the conducting pins may be selected as

$$\frac{{c}_{0}}{4 {f}_{1}} < L < \frac{{c}_{0}}{4 {f}_{2}}$$

The end of the stop band is always two times the start of the stop band (for the first one), i.e. c₀/4f₁<L<c₀/2f₁, where f₁ is the beginning of the stopband. This assumes no dielectric material. In that case the length is decreased by factor of

$$\frac{1}{\sqrt{{ε}_{r}}}$$

of the dielectric material. More simply one can write v/4f₁<L<v/2f₁
where v is the group velocity of TEM electromagnetic waves in that dielectric medium, or v=c₀/n where n is the refractive index of the material. The pins are not necessarily in air, but can be located in a dielectric medium. Encapsulating the pins in a dielectric medium may facilitate the manufacturing process and improve the robustness of the device.

Accordingly, in certain embodiments the length of the pins may longer than the speed of light in the medium in which the pins are embedded, divided by four times the lower frequency limit (f1) of the waveguide and shorter than the speed of light in the medium in which the pins are embedded, divided by two times the lower frequency limit (f1).

Optionally, the second antenna may also be provided with may be associated with further pin elements mounted on a second surface in accordance with any of the configurations described above, or any combination thereof, possibly in a different configuration to that of the first antenna.

The structure may optionally comprise still further surfaces, which may or may not conform to respective planes, with further respective antenna and/or pin element configurations.

Still further, any surface may comprise a plurality of antennas. Where a given surface comprises a plurality on antennas, each antenna may be associated with a respective set of pin elements, or a single set of pin elements may fully or partially surround all antenna in that surface.

It will be appreciated that in the context of the present invention it is of no significance where on the structure these surfaces are situated. As shown one is placed on each side of the pyramid structure but any other configuration may be envisaged.

As such, according to certain embodiments at least a second said antenna may be positioned in a second surface of said physical structure, wherein said first surface and said second surface are in different surfaces.

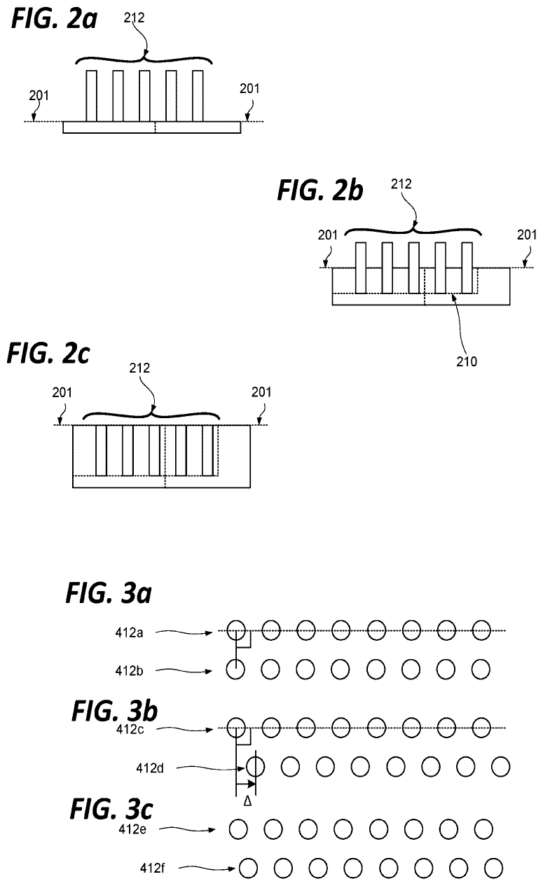

FIG. 2a shows a first example of relationship between the surface on which a set of rows is provided, and the surrounding surface.

As shown in FIG. 2a, the plane 201, which may correspond to the reference plane of an antenna, is intersected by the pins 212 at the lower, proximal extremity of each pin.

The PTSW modes can be excited by electric fields due to apertures adjacent to the wire medium. It is therefore expected that the wire medium supports propagation of PTSW modes below its cutoff frequency. Above the first cut off frequency, there are no PTSW modes. One would predict that coupling below cutoff due to the presence of a strongly bound PTSW mode can aid in coupling over larger distances. This mode becomes more and more confined closer to the surface because γ₀ gets larger and thus a stronger exponential decay. Besides the Transverse Magnetic (TM) modes in the pass band regions, there are also Transverse Electromagnetic (TEM) and Transverse Electric (TE) solutions if both the electric is polarized perpendicular to the wire medium. Certain implementations of the embedded wire medium may support TE modes. If the pins are placed inside a well, a TE mode can propagate through the channel, although this mode of operation may be less effective than implementations where the pins are situated above the plane of the antenna as described above. A covered medium realization of the meta material may act in a manner similar to a line of trees besides a highway reducing noise pollution. The medium seen as a homogenized medium supports an evanescent mode through it above the cutoff frequency of the wire medium.

The pin medium may be selected such that the plasma frequency is sufficiently far above the operating region of interest. The PTSW modes that are improper inside the stop band are solutions assuming that the medium operates below the plasma frequency. The plasma frequency is controlled via the wire spacing p and the wire radius r. The plasma phase constant kₚ=2πf/c₀ is always a fraction of the lattice vector kₐ=2π/p. This fraction decreases as the radius of the wire decreases for a given lattice spacing. For a ratio of r=0.1p the plasma phase constant kₚ is approximately 0.4 kₐ.

The choice of wires in practice depends on fabrication limits and when performing simulations on the mesh size. Very small wires are difficult to manufacturer robustly. Regarding simulations, designs with a small wire radius and lattice spacing will increase the complexity of the simulation model which makes them computationally expensive to solve.

The precise method at which the PTSW bandgap interferes with the coupling is difficult to determine as not only the geometries are complex and the wires need to be simulated with a significant size in order to limit the computational complexity which means that the homogenization model is less accurate. Depending on desired system characteristics and operating conditions, suitable wire radius values may be found to fall for example between 0.1 mm and 5 mm.

FIG. 2b shows a second example of a relationship between the surface on which a set of rows is provided, and the surrounding surface.

As shown in FIG. 2b, the plane 301 is intersected by the pins 212 at an intermediate point along the length of each pin, such that the pins are partially submerged with respect to the plane 201 in a well 210 disposed in the upper surface of the structure around the antenna.

FIG. 2c shows a third example of a relationship between the surface on which a set of rows is provided, and the surrounding surface.

As shown in FIG. 2c, the plane 201 is intersected by the pins 212 at the upper, distal extremity of each pin, such that the pins are fully submerged with respect to the plane 201 in a well 210.

As discussed above, a variety of different pin configurations may be envisaged.

FIGS. 3a, 3b and 3b present a number of such configurations.

FIG. 3a provides a plan view of a plurality of pin elements in a first configuration.

As shown in FIG. 3a, the pin elements of a first row of pins 412a are arranged in a substantially rectangular configuration with respect to the pin elements of a second row of pins 412b, with each pin in one row having its neighbour in adjacent rows directly opposite, on a line perpendicular to the line of the row upon which they are situated.

FIG. 3b provides a plan view of a plurality of pin elements in a second configuration.

As shown in FIG. 3b, the pin elements of a first row of pins 412c are arranged in a substantially rectangular configuration with respect to the pin elements of a second row of pins 412d, with each pin in one row having its neighbour in adjacent rows
offset one with respect to the next by an offset value Δ. As shown in FIG. 3b, the pins of a first row 412c are be offset with respect to the second, adjacent row 412d, by 0.5 times the distance between adjacent pins in the same row.

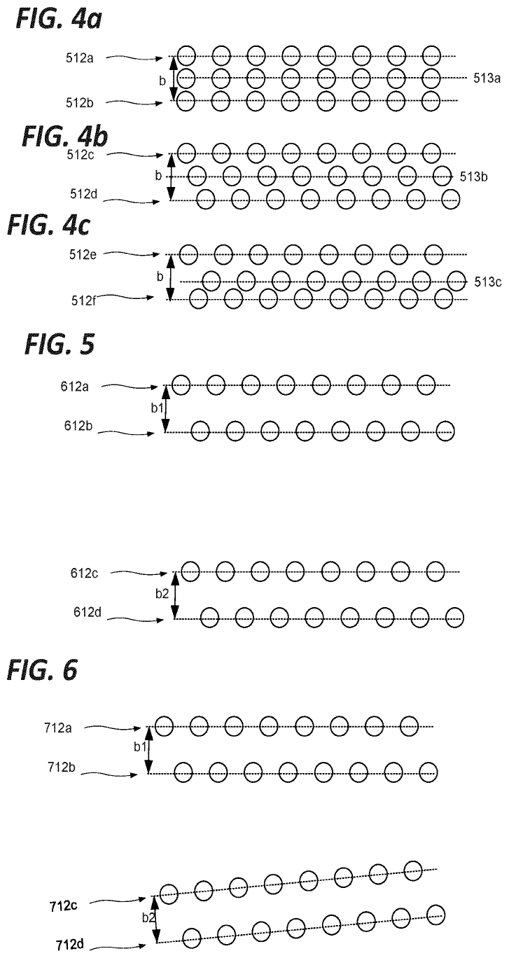

FIG. 4c provides a plan view of a plurality of pin elements in a third configuration.

As shown in FIG. 3c, the pin elements of a first row of pins 412e are arranged in a substantially rectangular configuration with respect to the pin elements of a second row of pins 412f, with each pin in one row having its neighbour in adjacent rows
offset one with respect to the next by an offset value Δ. As shown in FIG. 3c, the pins of a first row 412e are be offset with respect to the second, adjacent row 412f, by a value between 0.5 times the distance between adjacent pins in the same row and zero.

The foregoing embodiments have been describe with reference to first, inner row of pin elements and a second, outer row of pin elements, for the sake of simplicity, however embodiments encompass arrangements with three or more rows. Indeed, generally speaking, the more rows provided, the better the degree of screening that can be achieved. Accordingly, rows may define a square, or approximately square, or hexagonal, or approximately hexagonal matrix. It will be appreciated that the shape of the surface receding the pin elements may influence the possible configuration, so that, for example, outer rows may necessarily be incomplete. Meanwhile, the offset of pin elements from one row to the next as discussed for example with reference to FIGS. 4a, 4b and 4c need not be the same for all rows on a particular surface—the offset of some pairs of adjacent rows may differ from others. The number of successive rows on certain sides of the antenna may vary with respect to the number of successive rows on other sides.

As discussed above, the structure may comprise a plurality of antennas. The structure may define a number of surfaces, with one or more antennae provided in some or all of these surfaces. In accordance with the principles set out above, at least one antennae (e.g. the first antenna as described above) shares a surface with a plurality of pins as described above.

As described above, while an inner row and outer row are separated by a predetermined distance b, intermediate rows may be provided between the inner row and outer row. FIGS. 4a, 4b and 4c provide examples of configurations of intermediate rows.

FIG. 4a shows a first intermediate row configuration.

As shown in FIG. 4a, an inner row 512a, corresponding for example to inner row 112a as described above, and outer row 512b, corresponding for example to outer row 112b as described above, is provided, separated by the predetermined distance b as discussed previously. Furthermore, as shown an intermediate row 513a is provided. As shown, the pin elements of the inner and outer rows are aligned, and the intermediate row 513a is aligned with both the inner and outer row. The intermediate row is spaced equidistantly between the inner and outer rows.

In a variant, the pin elements of the inner and outer row might be offset, and the pin elements of the intermediate row aligned with the inner row or the outer row, or otherwise as discussed below.

FIG. 4b shows a second intermediate row configuration.

As shown in FIG. 4b, an inner row 512c, corresponding for example to inner row 112a as described above, and outer row 512d, corresponding for example to outer row 112b as described above, is provided, separated by the predetermined distance b as discussed previously. Furthermore, as shown an intermediate row 513b is provided. As shown, the pin elements of the inner and outer rows are offset by about 50%, and the intermediate row 513a is offset to a degree half the offset between the inner and outer rows. The intermediate row is spaced equidistantly between the inner and outer rows.

In a variant, the intermediate row may be offset by more or less than half of the offset between the inner row or the outer row, or otherwise as discussed below.

FIG. 4c shows a second intermediate row configuration.

As shown in FIG. 4c, an inner row 512e, corresponding for example to inner row 112a as described above, and outer row 512f, corresponding for example to outer row 112b as described above, is provided, separated by the predetermined distance b as discussed previously. Furthermore, as shown an intermediate row 513c is provided. As shown, the pin elements of the inner and outer rows are offset by about 70%, and the intermediate row 513a is offset to a degree half the offset between the inner and outer rows. The intermediate row is spaced closer to the outer row than to the inner row.

As such, it will be appreciate that a wide range of patterns may be envisaged for the placement of the pin elements, in particular based on any combination of the permutations presented above for example with respect to FIGS. 4a, 4b and 4c.

While for the sake of simplicity variants have been discussed with respect to a single intermediate row, any number of intermediate rows may be envisaged, and any combination of the permutations presented above for example with respect to FIGS. 4a, 4b and 4c applied to each intermediate row individually.

As discussed above, a set of row may be provided, a set comprising an inner and outer row, separated by a distance b, possibly together with intermediate rows, as discussed for example in the preceding embodiments. Meanwhile, in some embodiments a plurality of such sets of rows may be provided.

FIG. 5 presents a first configuration with multiple sets of rows.

As presented in FIG. 5, a first set of rows for example as defined in the preceding paragraph comprising an inner row 612a corresponding for example to outer row 112a as described above, and an outer row 612b corresponding for example to outer row 112b as described above, separated by a first distance b1 is provided. Furthermore a second set of rows comprising an inner row 612c corresponding for example to outer row 112a as described above, and an outer row 612d corresponding for example to outer row 112b as described above, separated by a second distance b2 is provided.

As shown the first set of rows and second set of rows are in parallel. In this configuration, multiple sets of rows may serve to reinforce the blockage of interference signals along the same propagation path.

Alternatively, or additionally, the distance b1 and b2 may be different, with the distance b being defined separately for each set, and thereby optimised to block different interference frequencies. This approach may be adopted where an antenna may operate selectively in different frequency bands, with respective row sets provided for each operating frequency band. Alternatively or additionally, respective sets of rows may be provided for a fundamental frequency and one or more harmonic frequencies.

FIG. 6 presents a first configuration with multiple sets of rows.

As presented in FIG. 6, a first set of rows comprising an inner row 712a corresponding for example to outer row 112a as described above, and an outer row 712b corresponding for example to outer row 112b as described above, separated by a first distance b1 is provided. Furthermore a second set of rows comprising an inner row 712c corresponding for example to outer row 112a as described above, and an outer row 712d corresponding for example to outer row 112b as described above, separated by a second distance b2 is provided.

As shown the first set of rows and second set of rows are in at different angles. In this configuration, each set of rows may serve to reinforce the blockage of interference signals along a different propagation path. In particular, where a structure comprises three or more antennas, row sets intersecting propagation paths between each pair of antennas may be desired. Such row sets may well intersect or overlap at certain parts of the surface of the structure.

Accordingly, as described herein, to limit interference between antennas such as radar patch antennas in a structure, rows of pin elements are provided intersecting a propagation path on the surface of the structure. These rows may comprise inner and outer rows separated by a predetermined distance determined as a function of the operating frequency of the antennas. One or more intermediate rows may be provided between the inner and outer rows. The length and diameter of pin elements as well as the spacing between pin elements of a given row, may equally be selected with a view to the operating frequency of the antennas. The pin elements of the inner and outer rows may be offset with respect to each other.

The examples described above are given as non-limitative illustrations of embodiments of the invention. They do not in any way limit the scope of the invention which is defined by the following claims.

1. A structure comprising two or more antennas, a first said antenna being arranged in a first surface of said structure and a second said antennae in a second surface of said structure, and a plurality of conductive pin elements arranged in one or more parallel rows intersecting a propagation path between said first antenna and said second antenna.

2. The structure of claim 1, wherein said plurality of conductive pin elements are arranged at a periphery of said antenna.

3. The structure of claim 1, wherein said plurality of conductive pin elements are arranged in one or more rows parallel to a periphery of said antenna.

4. The structure of claim 1, wherein said plurality of conductive pin elements is arranged in two or more rows parallel to said periphery of said antenna.

5. The structure of claim 4, wherein said antenna is designed to operate at a predetermined wavelength, and wherein said two or more rows comprise at least an inner row and an outer row, wherein of the main axis of said inner row is separated from the main axis of said outer row by a distance greater than one said wavelength.

6. The structure of claim 1, wherein the distance between each adjacent pair of pins in a given said row is a predetermined distance.

7. The structure of claim 6, wherein the diameter of each said pin is less than said predetermined distance.

8. The structure of claim 1, wherein the pins of a first said row are offset with respect to a second, adjacent said row parallel to said first row, along the axis of said first row, by an amount between 0.5 times the distance between adjacent pins in the same row and zero.

9. The structure of claim 1, wherein each said pin is formed contiguously with the structure.

10. The structure of claim 1, wherein each said pin is formed monolithically with the structure.

11. The structure of claim 1, wherein said first antenna comprises a two dimensional array of radiating elements, and a proximal extremity of each said pin in at least one said row coincides with said plane of said two-dimensional array.

12. The structure of claim 1, wherein said first antenna comprises a plurality of radiating elements, and wherein no said pins are provided between said radiating elements.

13. The structure of claim 12, wherein said plurality of conductive pin elements are arranged in one or more rows parallel to an outer periphery of said plurality of radiating elements.

14. The structure of claim 1, wherein the length of the pins is longer than the speed of light in the medium in which the pins are embedded, divided by four times the lower frequency limit (f1) of the waveguide and shorter than the speed of light in the medium in which the pins are embedded, divided by two times the lower frequency limit (f1).

15. The structure of claim 1, wherein at least a second said antenna is positioned in a second surface of said physical structure, wherein said first surface and said second surface are in different planes.
